(19) United States
(12) Patent Application Publication
(10) Pub. No.: US 2012/0074118 A1
(43) Pub. Date: Mar. 29, 2012

(54) Vehicle Heating System and Method Using PTC Heater

(75) Inventors: Yong Chul KIM, Hwaseong-si (KR); Tae Kun Kim, Ansan-si (KR); Hoo Taek Cho, Yongin-si (KR)

(73) Assignees: KIA MOTORS CORPORATION, Seoul (KR); HYUNDAI MOTOR COMPANY, Seoul (KR)

(21) Appl. No.: 12/954,336

(22) Filed: Nov. 24, 2010

(30) Foreign Application Priority Data
Sep. 28, 2010 (KR) 10-2010-0093886

(51) Int. Cl. B60L 1/04

(52) U.S. Cl. 219/202; 219/217

(57) ABSTRACT

A vehicle heating system using a PTC heater is provided, which includes an input unit for inputting set temperatures of a driver seat and a passenger seat, a control unit outputting PWM control signals so as to control respective outputs of a left heat source portion and a right heat source portion formed in the PTC heater based on the set temperatures input through the input unit, and a power supply unit supplying power to the left heat source portion and the right heat source portion, respectively, in accordance with the PWM control signals output from the control unit.

### CROSS-REFERENCE TO RELATED APPLICATION

This application is based on and claims priority from Korean Patent Application No. 10-2010-0093886, filed on Sep. 28, 2010 in the Korean Intellectual Property Office, the entire contents of which application is incorporated herein for all purposes by this reference.

### BACKGROUND OF THE INVENTION

1. Field of the Invention

The present invention relates to a vehicle heating system and method using a PTC heater, and more particularly, to a vehicle heating system and method using a PTC heater, which adjusts temperature of a left seat side (driver seat side) and a right seat side (passenger seat side) by applying left/right independent function to an electric heating device (PTC heater) included in an air conditioning system of an electric vehicle.

2. Description of the Prior Art

Generally, an air conditioning system for a vehicle includes a main body in which an evaporator, a heater, and the like are installed, a blower and a blower case installed inside the main body to send air into the main body.

The main body 1, as illustrated in FIG. 1, includes a ventilation discharge flow path 2 formed on one side of an upper portion of the main body to perform air conditioning, a defrost discharge flow path 4 formed on the other side of the upper portion of the main body to remove frost produced on a window, and a foot discharge flow path 6 formed on a front side of the main body to discharge air toward driver's feet or passenger's feet.

Also, inside the main body 1, an evaporator 14 cooling air flowing from an air inlet port 12, a hot-water heater core 15 heating the air, and a PTC heater 16 that is used before the heating of the hot-water heater core 15 are provided. Between the evaporator 14 and the hot-water heater core 15, an air mix door 18 adjusting the temperature of the ventilation air is installed.

The air mix door 18, as illustrated in FIG. 2, adjusts the temperature in a vehicle compartment by adjusting the mixing ratio of cold air and hot air passing through the hot-water heater core 15 and the PTC heater 16. The air mix door includes a first air mix door 18a adjusting the temperature of a driver seat side and a second air mix door 18b adjusting the temperature of a passenger seat side, and the first and second air mix doors 18a and 18b are individually driven by a motor in a left/right independent control manner.

However, the hot-water heater core 15 by engine coolant, which is adopted in the air conditioning system for a vehicle in the related art, is not applied to a future electric vehicle, and thus a replaceable heat source is required.

Further, since the air conditioning system for a vehicle in the related art should be separately provided with the first and second air mix doors 18a and 18b and the motor to adjust the temperature of the driver seat side and the passenger seat side, the manufacturing cost thereof is increased, and the size of the main body 1 is also increased.

The information disclosed in this Background section is only for enhancement of understanding of the general background of the invention and should not be taken as an acknowledgement or any form of suggestion that this information forms the prior art already known to a person skilled in the art.

### SUMMARY OF THE INVENTION

Accordingly, various aspects of the present invention have been made to solve the above-mentioned problems occurring in the prior art while advantages achieved by the prior art are maintained intact.

One aspect of the present invention is to provide a vehicle heating system using a PTC heater, which can be applied to an electric vehicle and can perform individual temperature adjustment of a driver seat and a passenger seat even without separate air mix doors through improvement of the structure and the control method of the PTC heater and utilization of the PTC heater as a main heat source for heating.

In another aspect of the present invention, there is provided a vehicle heating system using a PTC heater, which includes an input unit for inputting set temperatures of a driver seat and a passenger seat, a control unit outputting PWM control signals so as to control respective outputs of a left heat source portion and a right heat source portion formed in the PTC heater based on the set temperatures input through the input unit, and a power supply unit supplying power to the left heat source portion and the right heat source portion, respectively, in accordance with the PWM control signals output from the control unit.

The PTC heater may include left and right temperature sensing units measuring the temperatures of air discharged through the left heat source portion and the right heat source portion, respectively, and the control unit may output the PWM control signals for controlling the outputs of the left heat source portion and the right heat source portion, respectively, by comparing the temperatures measured through the left and right temperature sensing units with the set temperatures input through the input unit, respectively.

The left and right temperature sensing units may be installed to be spaced apart from air discharge surfaces of the left heat source portion and the right heat source portion, respectively.

The left heat source portion or the right heat source portion may include a plurality of PTC elements, and the PTC elements may be arranged so that the number of the PTC elements is increased toward a lower part of the left heat source portion or the right heat source portion.

In another aspect of the present invention, there is provided a vehicle heating method using a PTC heater, which includes the steps of A) inputting set temperatures of a driver seat and a passenger seat, B) comparing the set temperatures of the driver seat and the passenger seat input in step A) with measured temperatures of air discharged through left and right heat source portions of the PTC heater, and C) outputting PWM control signals for controlling outputs of the left and right heat source portions, respectively, by comparing the set temperatures of the driver seat and the passenger seat input in step A) with the measured temperatures of the air passing through the left and right heat source portions, respectively.

The step C) may output the PWM control signal for increasing voltage input to the left heat source portion or the right heat source portion to increase the temperature of the left heat source portion or the right heat source portion if the measured temperature of the left heat source portion or the right heat source portion is lower than the set temperature of the driver seat or the passenger seat.

The step C) may output the PWM control signal for decreasing voltage input to the left heat source portion or the right heat source portion to lower the temperature of the left heat source portion or the right heat source portion if the measured temperature of the left heat source portion or the right heat source portion is higher than the set temperature of the driver seat or the passenger seat.

The step C) may output the PWM control signal for maintaining voltage input to the left heat source portion or the right heat source portion to maintain the temperature of the left heat source portion or the right heat source portion if the measured temperature of the left heat source portion or the right heat source portion is equal to the set temperature of the driver seat or the passenger seat.

According to the vehicle heating system and method using a PTC heater according to the present invention, the structure and the control method of the PTC heater are improved and the PTC heater is used as a main heat source for heating. Accordingly, the vehicle heating system and method according to the present invention can be applied to an electric vehicle and can perform individual temperature adjustment of a driver seat and a passenger seat even without separate air mix doors.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a view schematically illustrating a vehicle heating system using a PTC heater in the related art.

FIG. 2 is a perspective view illustrating a vehicle heating system using a PTC heater in the related art.

FIG. 3 is a view illustrating a vehicle heating system using an exemplary PTC heater according to the present invention.

FIG. 4 is a view illustrating a PTC heater of an exemplary vehicle heating system according to the present invention.

FIGS. 5A to 5D are views illustrating a PTC heater of an exemplary vehicle heating system according to the present invention.

FIG. 6 is a flowchart illustrating an exemplary vehicle heating method using a PTC heater according to the present invention.

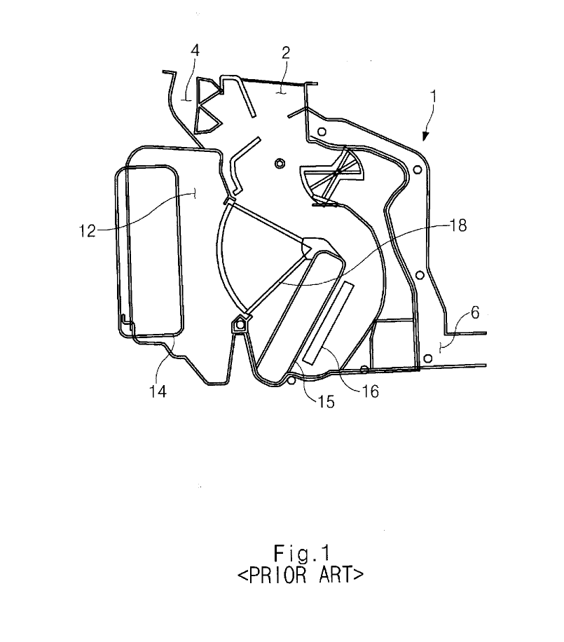

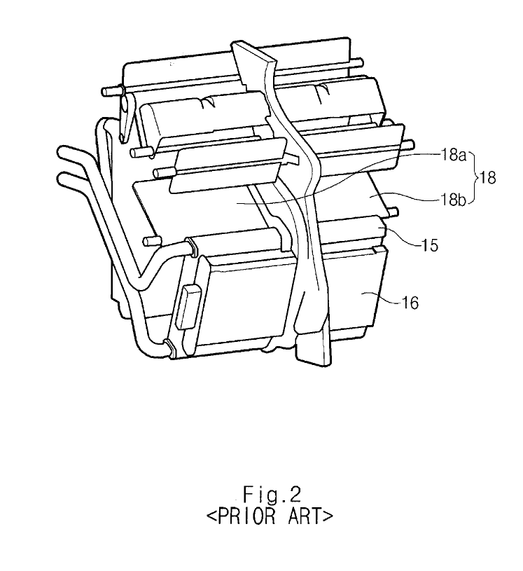

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

A vehicle heating system and method using a PTC (Positive Temperature Coefficient) heater according to various embodiments of the present invention relates to a technique that can adjust the temperatures of air discharged to a driver seat and a passenger seat, respectively, by differently adjusting the temperatures on the left and right sides of the PTC heater through individual control of left and right heat source portions of the PTC heater. Accordingly, the size of a heater unit and the number of components are reduced, and thus the manufacturing is facilitated with the reduction of weight.

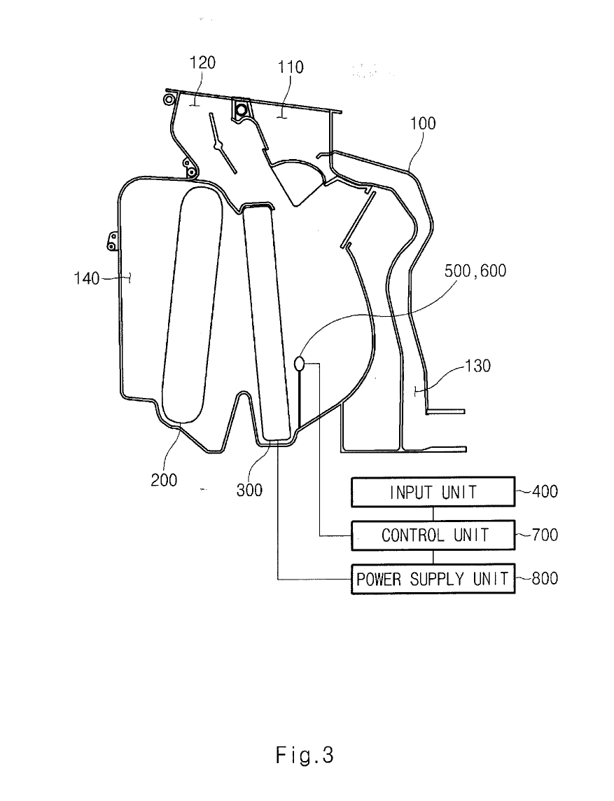

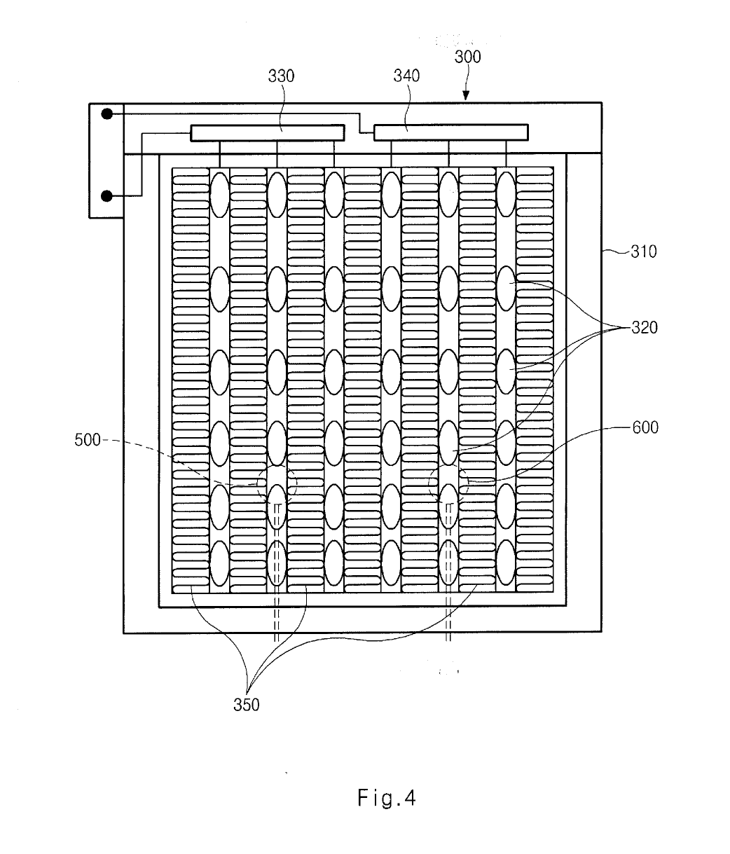

The vehicle heating system using a PTC heater according to various embodiments of the present invention, as illustrated in FIGS. 3 and 4, includes a main body 100, an evaporator 200 built in the main body 100, a PTC heater 300, an input unit 400 for inputting set temperatures of a driver seat and a passenger seat, left and right temperature sensing units 500 and 600 sensing temperatures of air passing through the left side and the right side of the PTC heater 300, a control unit 700 outputting PWM control signals for controlling the PTC heater 300 based on the set temperatures input through the input unit 400 and measured temperatures measured by the left and right temperature sensing units 500 and 600, and a power supply unit 800 supplying power to the PTC heater 300 in accordance with the PWM control signals output from the control unit 700.

The main body 100 includes a ventilation discharge flow path 110 formed on one side of an upper portion of the main body to perform air conditioning in the vehicle, a defrost discharge flow path 120 formed on the other side of the upper portion of the main body to remove frost produced on a window, a foot discharge flow path 130 formed on the rear side of the main body to discharge air toward driver's feet or passenger's feet, and an air inlet port 140 formed on the front side of the main body for inflow of external air.

Also, in the air inlet port 140 of the main body 100, an evaporator 200 and a PTC heater 300 to be described later are installed. Air having passed through the air inlet port 140 is heated as it passes through the PTC heater 300, and then is discharged to one or more of the ventilation discharge flow path 110, the defrost discharge flow path 120, and the foot discharge flow path 130.

The evaporator 200 is configured to cool air that flows in from the outside, and installed on the air inlet port 140 of the main body 100.

The PTC heater 300 is configured to heat air that passes through the evaporator 200 and operated electrically. The PTC heater 300 is installed in the inside of the main body 100 to generate warm air having a different temperature depending on the amount of current applied from the power supply unit 800.

That is, in the PTC heater 300, if a large amount of current is applied, the temperature of the heating device is heightened and high-temperature hot air is generated, while if a small amount of current is applied, the temperature is relatively lowered and low-temperature hot air is generated.

The PTC heater 300, as illustrated in FIG. 4, includes a main body 310 and left and right heat source portions 330 and 340, which are provided on left and right sides of the main body 310 and include a plurality of PTC elements 320 arranged from top to bottom. Heat dissipation fins 350 for dissipating heat are provided between the left and right heat source portions 330 and 340.

That is, if different current is applied to the left heat source portion 330 and the right heat source portion 340 of the PTC heater 300, the left heat source portion 330 and the right heat source portion 340 generate hot air having different temperatures, and thus the hot air supplied to the driver seat and the passenger seat can be independently adjusted.

Here, the PTC elements 320 provided in the left and right heat source portions 330 and 340 are arranged so that the number of PTC elements is increased toward the lower part of the left and right heat source portions. That is, by arranging a larger number of PTC elements 320 on the lower part of the left and right heat source portions 330 and 340, the temperature of the hot air being supplied to the driver's feet and the passenger's feet can be increased.

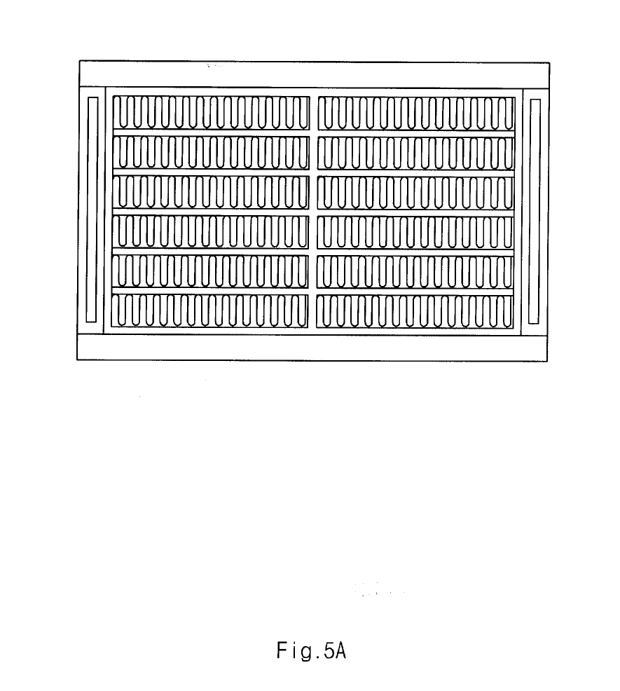

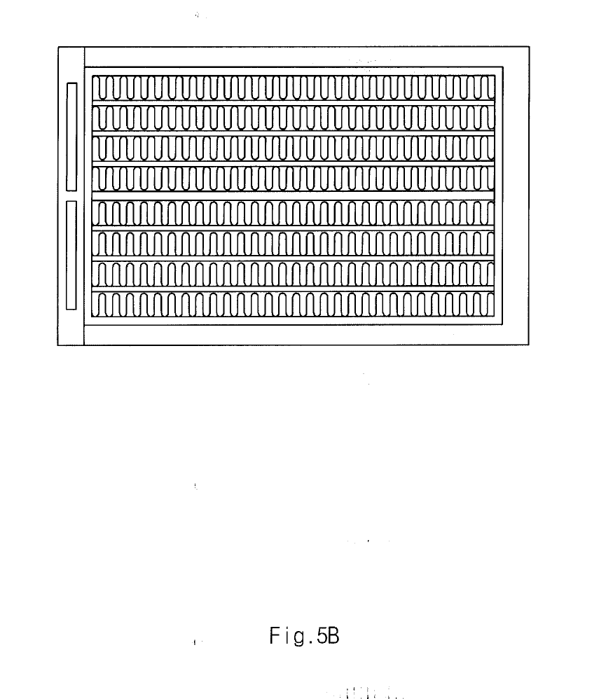

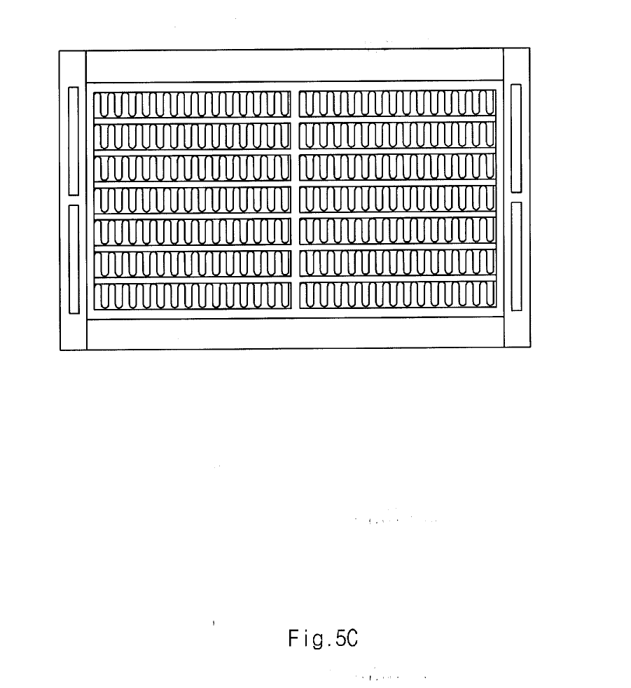

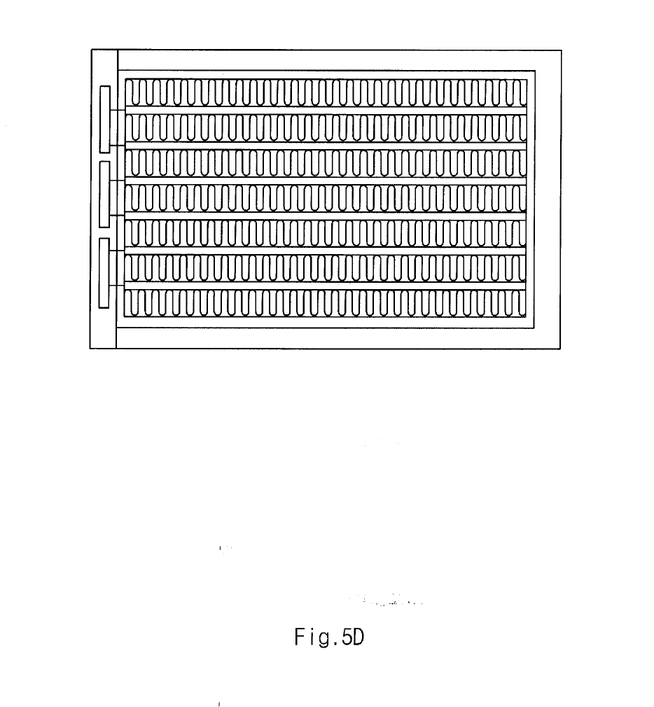

On the other hand, the left and right heat source portions 330 and 340 formed in the PTC heater 300 may be arranged left and right as illustrated in FIG. 5A, or may be arranged up and down as illustrated in FIG. 5B. Also, the left and right heat source portions 330 and 340 may be divided into four parts in up, down, left, and right directions as illustrated in FIG. 5C, or may be divided into two parts in two rows illustrated in FIG. 5D.

The input unit 400 receives user's input of set temperatures for setting the temperatures of the left and right heat source portions 330 and 340 formed in the PTC heater 300. That is, the input unit 400 receives set temperatures of the driver seat and the passenger seat.

The control unit 700 generates PWM (Pulse Width Modulation) control signals in accordance with the set temperature that the user has input through the input unit 400, and outputs the generated PWM control signals to the power supply unit 800 to control voltages for driving the left and right heat source portions 330 and 340 of the PTC heater 300.

That is, the control unit 700 independently controls the left heat source portion 330 and the right heat source portion 340 by controlling the voltages supplied to the left heat source portion 330 and the right heat source portion 340, respectively, in accordance with the set temperatures through the input unit 400.

On the other hand, the term “PWM” is a pulse modulation type for changing the pulse width in accordance with the size of the modulated signal. If the amplitude of the control signal is large, the pulse width is widened, while if the amplitude of the control signal is small, the pulse width is narrowed. Since the position or amplitude of the pulse is not changed, the amount of current applied to the PTC heater 300 can be adjusted through the change of the pulse width. Accordingly, relatively high energy efficiency can be obtained in comparison to the voltage control type. By outputting the PWM control signal to the power supply unit 800, the temperature of the PTC heater 300 can be varied.

Here, the PTC heater 300 is provided with left and right temperature sensing units 500 and 600 for measuring the temperatures of air discharged from the left heat source portion 330 and the right heat source portion 340.

The left and right temperature sensing units 500 and 600 are installed to be spaced apart for a predetermined distance from air discharge surfaces of the left heat source portion 330 and the right heat source portion 340, respectively.

Accordingly, the control unit 700 controls the outputs of the left heat source unit 330 and the right heat source unit 340 by comparing the temperatures measured through the left and right temperature sensing units 500 and 600 with the set temperatures input through the input unit 400, respectively.

The power supply unit 800 supplies the power to the left and right heat source units 330 and 340 when the PWM control signals are input from the control unit 700.

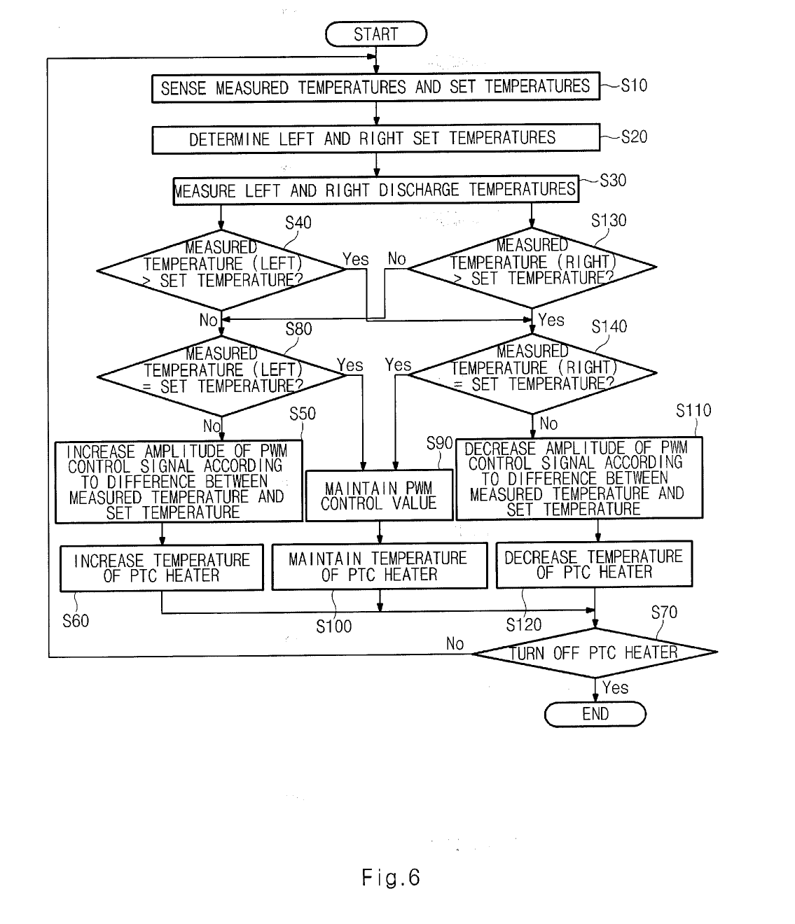

A vehicle heating method using a PTC heater according to various embodiments of the present invention will be described with reference to FIG. 6.

First, when the power of the vehicle is applied, temperatures measured by respective sensors and set temperatures are sensed (step S10). A user inputs the set temperatures for setting the temperatures of the driver seat and the passenger seat (step S20). Temperatures of air discharged through the left and right heat source portions 330 and 340 of the PTC heater 300 are measured through the left and right temperature sensing units 500 and 600 (step S30).

Then, PWM control signals for controlling the left and right heat source portions 330 and 340 of the PTC heater 300 are output to the power supply unit 800 through comparison of the set temperatures input by the user through the input unit 400 with the temperatures measured by the left and right temperature sensing units 500 and 600.

### Control of Left Heat Source Portion

If the temperature measured by the left temperature sensing unit 500 that is positioned in the left heat source portion 330 is lower than the set temperature of the driver seat (step S40), the PWM control signal for increasing the voltage input to the left heat source portion 330 of the PTC heater 300 is output to the power supply unit 800 in proportion to the difference between the measured temperature and the set temperature (step S50). Accordingly, the power supply unit 800 supplies the corresponding power to the left heat source portion 330, and the left heat source portion 330 increases the temperature of the discharged air (step S60).

Here, if the temperature measured from the left temperature sensing unit 500 is equal to the set temperature of the driver seat (step S80), the current PWM control value is maintained (step S90), and thus the temperature of the left heat source portion 330 of the PTC heater 300 is maintained without any change (step S100).

On the other hand, if the temperature measured from the left temperature sensing unit 500 is higher than the set temperature of the driver seat, the PWM control signal for decreasing the voltage input to the left heat source portion 330 of the PTC heater 300 is output to the power supply unit 800 in proportion to the difference between the measured temperature and the set temperature (step S110). Accordingly, the power supply unit 800 supplies the corresponding power to the left heat source portion 330, and the left heat source portion 300 decreases the temperature of the discharged air (step S120).

### Control of Right Heat Source Portion

If the temperature measured by the right temperature sensing unit 600 that is positioned in the right heat source portion 340 is lower than the set temperature of the passenger seat (step S130), the PWM control signal for increasing the voltage input to the right heat source portion 340 of the PTC heater 300 is output to the power supply unit 800 in proportion to the difference between the measured temperature and the set temperature (step S50). Accordingly, the power supply unit 800 supplies the corresponding power to the right heat source portion 340, and the right heat source portion 340 increases the temperature of the discharged air (step S60).

On the other hand, if the temperature measured from the right temperature sensing unit 600 is higher than the set temperature of the passenger seat, the PWM control signal for decreasing the voltage input to the right heat source portion 340 of the PTC heater 300 is output to the power supply unit 800 in proportion to the difference between the measured temperature and the set temperature (step S110). Accordingly, the power supply unit 800 supplies the corresponding power to the right heat source portion 340, and the right heat source portion 340 decreases the temperature of the discharged air (step S120).

Here, if the temperature measured from the right temperature sensing unit 600 is equal to the set temperature of the passenger seat (step S80), the current PWM control value is maintained (step S90), and thus the temperature of the right heat source portion 340 of the PTC heater 300 is maintained without any change (step S100).

### When PTC Heater is Turned Off

Next, it is judged whether a signal for turning off the PTC heater 300 is input (step S70). If the turn-off signal is not input, the process returns to step S10 to control the temperatures of the left and right heat source portions 330 and 340 of the PTC heater 300, while if the turn-off signal is input, the operation of the PTC heater 300 is stopped.

According to the vehicle heating method using a PTC heater according to various embodiments of the present invention, the hot air supplied to the driver seat and the passenger seat can be independently adjusted by controlling the left and right heat source portions 330 and 340 of the PTC heater 300 to operate independently.

For convenience in explanation and accurate definition in the appended claims, the terms “upper” or “lower”, “front” or “rear”, “inside”, and etc. are used to describe features of the exemplary embodiments with reference to the positions of such features as displayed in the figures.

The foregoing descriptions of, specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A vehicle heating system using a PTC heater, comprising:
an input unit for inputting set temperatures of a driver seat and a passenger seat;
a control unit outputting PWM control signals so as to control respective outputs of a left heat source portion and a right heat source portion formed in the PTC heater based on the set temperatures input through the input unit; and
a power supply unit supplying power to the left heat source portion and the right heat source portion, respectively, in accordance with the PWM control signals output from the control unit.

2. The vehicle heating system according to claim 1, wherein the PTC heater comprises left and right temperature sensing units measuring the temperatures of air discharged through the left heat source portion and the right heat source portion, respectively, and
the control unit outputs the PWM control signals for controlling the outputs of the left heat source portion and the right heat source portion, respectively, by comparing the temperatures measured through the left and right temperature sensing units with the set temperatures input through the input unit, respectively.

3. The vehicle heating system according to claim 2, wherein the left and right temperature sensing units are installed to be spaced apart from air discharge surfaces of the left heat source portion and the right heat source portion, respectively.

4. The vehicle heating system according to claim 1, wherein the left heat source portion or the right heat source portion includes a plurality of PTC elements, and
the PTC elements are arranged so that the number of the PTC elements is increased toward a lower part of the left heat source portion or the right heat source portion.

5. A vehicle heating method using a PTC heater, comprising the steps of:
A) inputting set temperatures of a driver seat and a passenger seat;
B) comparing the set temperatures of the driver seat and the passenger seat input in step A) with measured temperatures of air discharged through left and right heat source portions of the PTC heater; and
C) outputting PWM control signals for controlling outputs of the left and right heat source portions, respectively, by comparing the set temperatures of the driver seat and the passenger seat input in step A) with the measured temperatures of the air passing through the left and right heat source portions, respectively.

6. The vehicle heating method according to claim 5, wherein the step C) outputs the PWM control signal for increasing voltage input to the left heat source portion or the right heat source portion to increase the temperature of the left heat source portion or the right heat source portion if the measured temperature of the left heat source portion or the right heat source portion is lower than the set temperature of the driver seat or the passenger seat.

7. The vehicle heating method according to claim 5, wherein the step C) outputs the PWM control signal for decreasing voltage input to the left heat source portion or the right heat source portion to lower the temperature of the left heat source portion or the right heat source portion if the measured temperature of the left heat source portion or the right heat source portion is higher than the set temperature of the driver seat or the passenger seat.

8. The vehicle heating method according to claim 5, wherein the step C) outputs the PWM control signal for maintaining voltage input to the left heat source portion or the right heat source portion to maintain the temperature of the left heat source portion or the right heat source portion if the measured temperature of the left heat source portion or the right heat source portion is equal to the set temperature of the driver seat or the passenger seat.
